(19) United States
(12) Patent Application Publication
(10) Pub. No.: US 2026/0225426 A1
(43) Pub. Date: Aug. 6, 2026

(54) AIR CONDITIONING SYSTEM AND CONTROL METHOD OF AIR CONDITIONING SYSTEM

(71) Applicant: TOYOTA JIDOSHA KABUSHIKI KAISHA, Toyota-shi (JP)

(72) Inventors: Hisashi JUFUKU, Seto-shi (JP); Takumi YASHIMA, Toyota-shi (JP)

(73) Assignee: TOYOTA JIDOSHA KABUSHIKI KAISHA, Toyota-shi (JP)

(21) Appl. No.: 19/434,672

(22) Filed: Dec. 29, 2025

(30) Foreign Application Priority Data
Feb. 3, 2025 (JP) 2025-016293

(51) Int. Cl. B60H 1/00

(52) U.S. Cl. CPC B60H 1/00878; B60H 2001/00935

(57) ABSTRACT

An air conditioning system is configured to dispose an engine, a predetermined air conditioning unit, a first heat exchanger, and a second heat exchanger in parallel, and includes a controller to control a four-way switching valve to open a second flow path and a third flow path during refrigerant water injection to execute a first mode, and to switch between a second mode in which the four-way switching valve is controlled to open a first flow path and the third flow path and a third mode in which the four-way switching valve is controlled to open the first flow path and a fourth flow path after executing the first mode, switches repeatedly between the second mode and the third mode.

### CROSS-REFERENCE TO RELATED APPLICATION

This application claims priority to Japanese Patent Application No. 2025-016293 filed on Feb. 3, 2025. The disclosure of the above-identified application, including the specification, drawings, and claims, is incorporated by reference herein in its entirety.

### BACKGROUND

### 1. Technical Field

The present disclosure relates to an air conditioning system.

### 2. Description of Related Art

Japanese Unexamined Patent Application Publication No. 2023-063735 (JP 2023-063735 A) discloses a technique for harmonizing cooling of a battery with a defrost function of a vehicle.

### SUMMARY

Incidentally, in a plug-in hybrid electric vehicle (PHEV), the refrigerant circuit configuration is complex due to the coexistence of a refrigerant circuit responsible for cooling an engine and a refrigerant circuit responsible for cooling a battery in an air conditioning unit. In such a complex refrigerant circuit, air tends to remain in the piping when the refrigerant is replenished or replaced, and there is a possibility that the operation time is prolonged. Therefore, there is room for improvement in the control of the refrigerant circuit.

An object of the present disclosure is to provide an air conditioning system and a control method of an air conditioning system that enable the discharge of residual air in a short time in a complex refrigerant circuit of a vehicle.

An air conditioning system according to a first aspect of the present disclosure includes:

a refrigerant circuit; and

a controller configured to control a four-way switching valve, in which:

the refrigerant circuit includes an engine, an air conditioning unit that is predetermined, a first heat exchanger, and a second heat exchanger that are disposed in parallel, and includes a water pump and the four-way switching valve;

the refrigerant circuit is configured such that the engine and the first heat exchanger are disposed upstream in the circuit and the air conditioning unit and the second heat exchanger are disposed downstream in the circuit, and the water pump and the four-way switching valve are provided downstream in the circuit in a symmetrical manner;

the refrigerant circuit includes a first flow path connecting the engine and the first heat exchanger to the four-way switching valve, a second flow path connecting the water pump to the four-way switching valve, a third flow path connecting the air conditioning unit to the four-way switching valve, and a fourth flow path connecting the second heat exchanger to the four-way switching valve; and

the controller is configured to, during refrigerant water injection, execute a first mode in which the four-way switching valve is controlled to open the second flow path and the third flow path, and, after executing the first mode, execute control such that a second mode in which the four-way switching valve is controlled to open the first flow path and the third flow path and a third mode in which the four-way switching valve is controlled to open the first flow path and the fourth flow path are alternately switched and executed repeatedly.

As a result, the discharge of the residual air is enabled in a short time in the complex refrigerant circuit of the vehicle.

An air conditioning system according to a second aspect is the air conditioning system according to the first aspect, in which the controller is configured to execute control such that an output of the water pump is a low output until a transition from the first mode to the second mode, and then the output is switched to a high output when the mode is switched from the second mode to the third mode. With the air conditioning system according to the second aspect, the blowing out of coolant can be prevented.

According to the technique of the present disclosure, the discharge of the residual air is enabled in a short time in the complex refrigerant circuit of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of an air conditioning system of the present embodiment;

FIG. 2 is an example of switching of a flow path by mode control of a four-way switching valve;

FIG. 3 is an example of switching of a flow path by mode control of a four-way switching valve;

FIG. 4 is an example of switching of a flow path by mode control of a four-way switching valve;

FIG. 5 shows an example of a time chart of the mode control; and

FIG. 6 is a flowchart for describing a flow of processing of the present embodiment.

### DETAILED DESCRIPTION OF EMBODIMENTS

An outline of an embodiment of the present disclosure will be described. In recent years, the cooling drain pipes in battery electric vehicles, particularly in PHEVs, have become increasingly complex. In PHEVs, the addition of an engine has led to increased complexity in the refrigerant circuit system, resulting in a plurality of branches and merge points in the flow paths. Therefore, it is necessary to inject a greater amount of coolant into a complex flow path compared to a BEV vehicle. In such a complex system, there is a problem in that the water injection performance deteriorates, resulting in a longer water injection time and a tendency for air bubbles to remain. In addition, the flow path bends vertically, and there is also a problem in that air bubbles tend to remain in a portion protruding upward. Air bubbles remaining in the system during water injection may decrease heating performance and engine cooling performance and increase the component failure rate. In addition, in a case where the water pump is operated to switch the flow path during water injection, the coolant is blown out from the injection port due to the variation in the water flow resistance. Due to the various challenges as described above, there was a problem that it was difficult to discharge air inside the piping when injecting coolant into the piping, resulting in increased operation time and decreased cooling performance.

Therefore, in the present embodiment, an air conditioning system related to a control method of a water pump and a water circuit switching valve (four-way switching valve) is proposed so that air inside the piping can be efficiently discharged. The air conditioning referred to herein is air conditioning for controlling the discharge of air (residual air) in the refrigerant circuit.

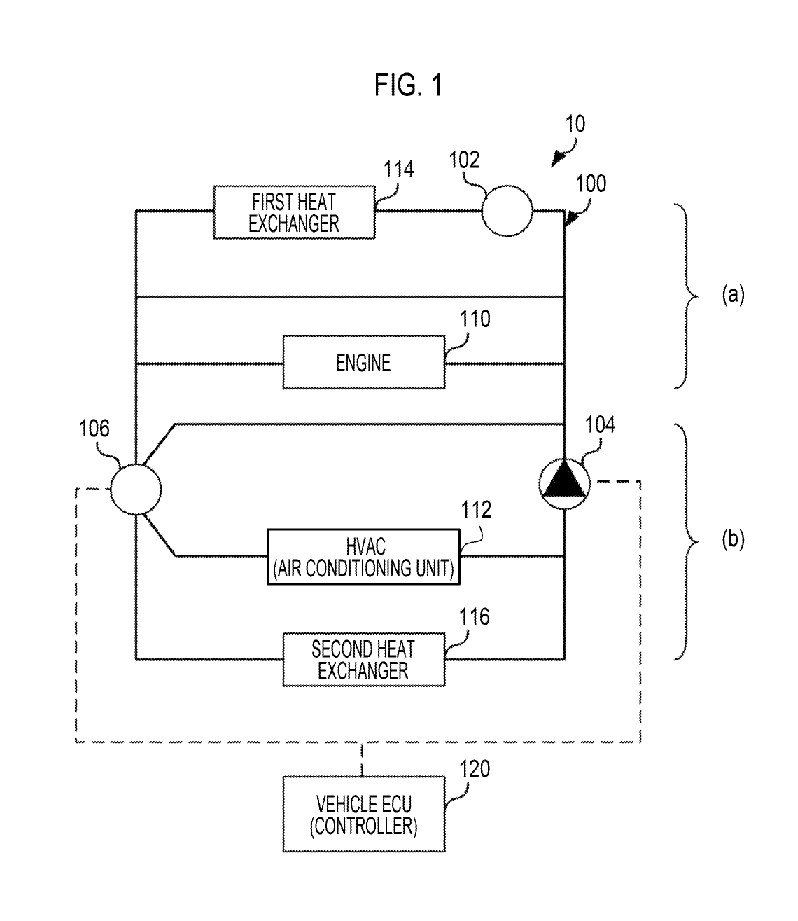

FIG. 1 is a diagram showing a configuration of an air conditioning system 10 of the present embodiment. As shown in FIG. 1, the air conditioning system 10 includes a refrigerant circuit 100 and a vehicle ECU 120 that controls the refrigerant circuit 100, which are connected. The vehicle ECU 120 is an example of a controller of the present disclosure.

The refrigerant circuit 100 includes an injection port 102, a water pump 104, a four-way switching valve 106, an engine 110, a predetermined air conditioning unit (HVAC: Heating, Ventilation, and Air Conditioning) 112, a first heat exchanger 114, and a second heat exchanger 116 as a configuration. The HVAC 112, the first heat exchanger 114, and the second heat exchanger 116 are disposed in parallel, the engine 110 and the first heat exchanger 114 are disposed on an upstream path (a) of the circuit, and the HVAC 112 and the second heat exchanger 116 are disposed on a downstream path (b) of the circuit. In addition, the water pump 104 and the four-way switching valve 106 are provided symmetrically downstream and are connected to the vehicle ECU 120.

The vehicle ECU 120 is implemented by a computer including a central processing unit (CPU), a read only memory (ROM) that stores a program or the like for implementing various types of processing, a random access memory (RAM) that temporarily stores data, a memory as a storage unit, a network interface, and the like as a hardware configuration.

The water pump 104 is controlled by the vehicle ECU 120 and is a pump that is electrically operated. The four-way switching valve 106 is controlled by the vehicle ECU 120, and is a switching valve that can switch a flow path when the refrigerant water is injected.

A water injection process of the refrigerant circuit will be described. The trigger of the start of the water injection is received from the outside of the vehicle to operate the water pump 104. The trigger is received from a navigation operation for the vehicle ECU 120 or from a connector that is connected. After the water pump 104 is operated, the coolant is replenished through the injection port 102 (refrigerant water injection). As a result, the coolant is injected from the upstream. The four-way switching valve 106 switches a flow path of the refrigerant circuit. Here, the water pump 104 and the four-way switching valve 106 are controlled in coordination with each other to prevent the ejection of the coolant.

In the refrigerant circuit 100, air bubbles are pushed toward the injection port 102 by operating the water pump 104 during water injection from the injection port 102. By switching the flow path of the coolant, the amount of water flowing through the flow path can be increased, and air bubbles can be more efficiently discharged. In addition, in a case where the flow path is branched, the water is divided and flows, so that the flow rate decreases, and the discharge performance of air bubbles decreases.

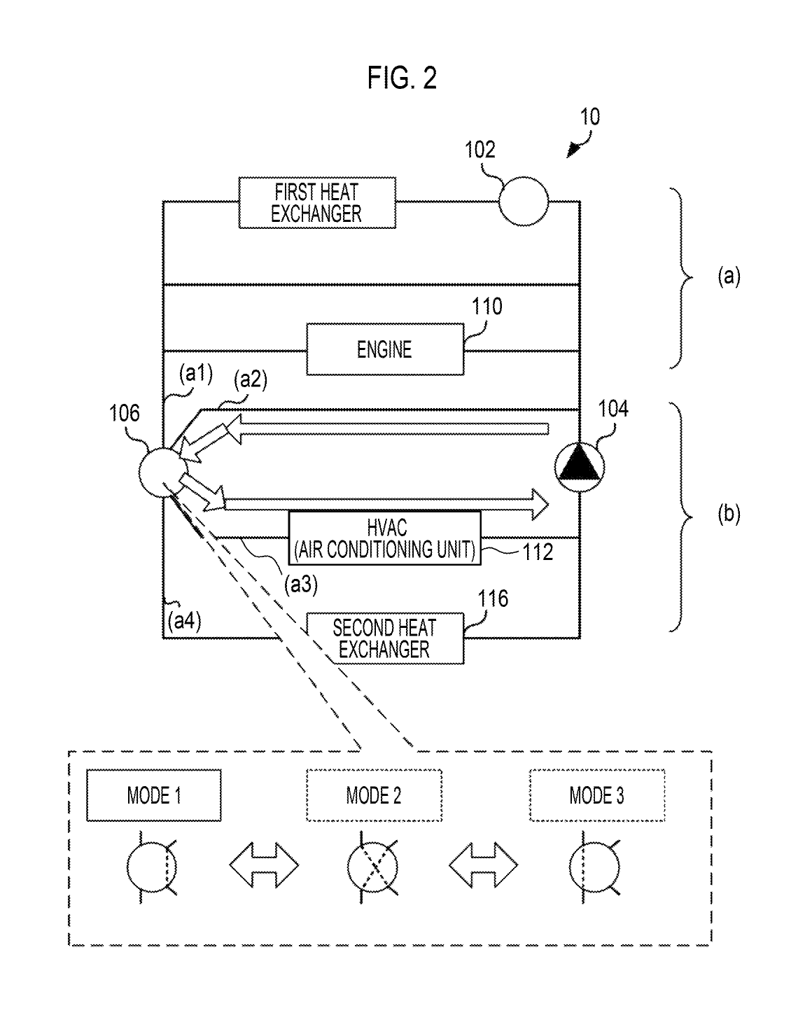

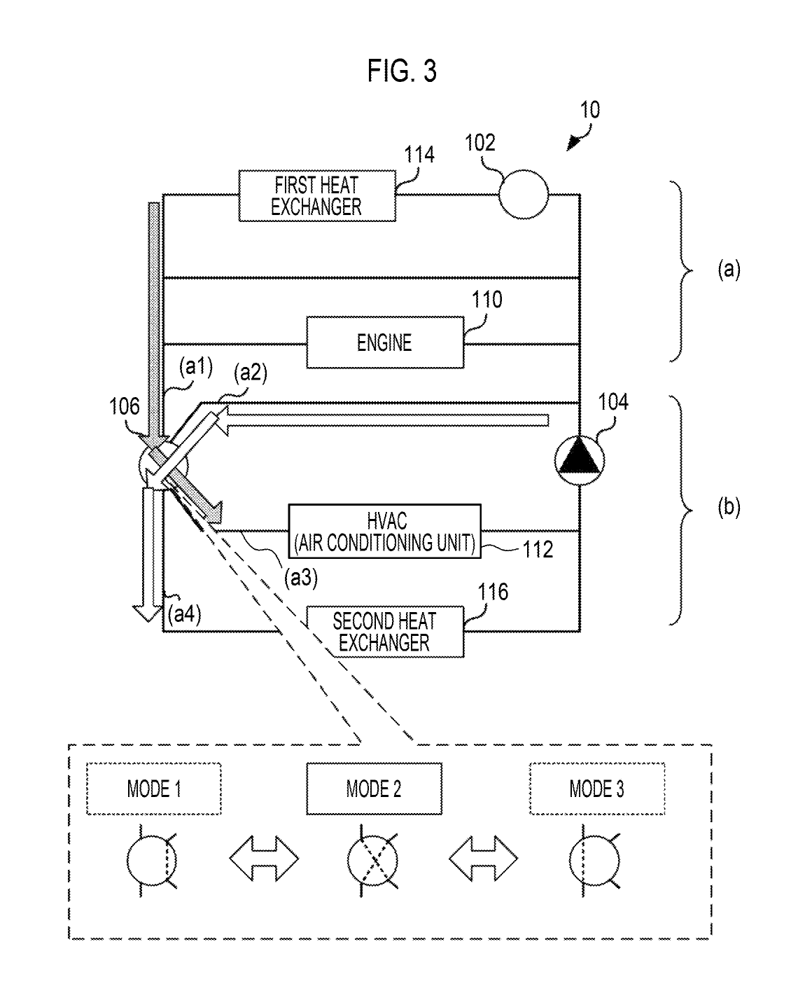

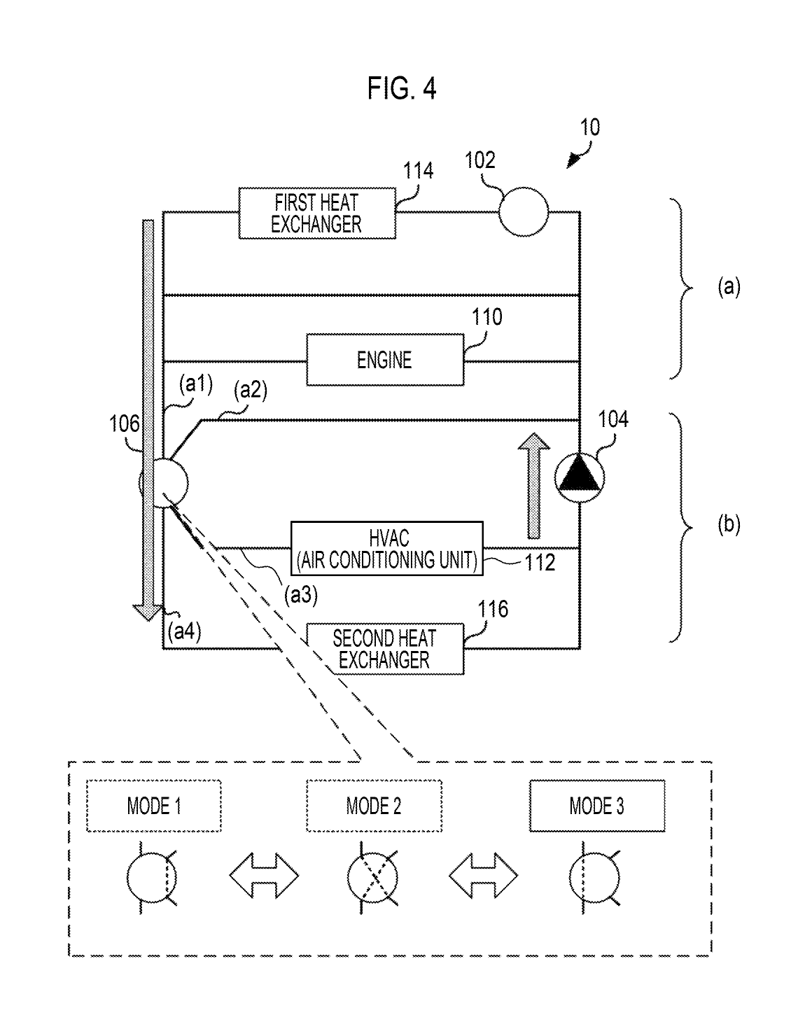

In the air conditioning system 10 of the present embodiment, the switching of the flow path is executed by the mode control. FIGS. 2 to 4 are examples of switching of a flow path by mode control of the four-way switching valve. FIG. 2 illustrates a first mode, FIG. 3 illustrates a second mode, and FIG. 4 illustrates a third mode. As a flow path of the refrigerant circuit, a first flow path (a1), a second flow path (a2), a third flow path (a3), and a fourth flow path (a4) are shown. The first flow path (a1) is a flow path connecting the engine 110, the first heat exchanger 114, and the four-way switching valve 106. The second flow path (a2) is a flow path connecting the water pump 104 and the four-way switching valve 106. The flow path closed by the four-way switching valve 106 is in a state where the coolant (used as refrigerant) is blocked.

The vehicle ECU 120 is configured to, in controlling the four-way switching valve 106, execute control such that the second mode and the third mode are alternately switched and executed repeatedly after executing the first mode.

In the first mode, the four-way switching valve 106 is controlled to open the second flow path (a2) and the third flow path (a3) when the refrigerant water is injected. In this case, the upstream side is blocked, but the downstream side is switched to allow flow from the second flow path (a2) to the third flow path (a3). Next, the vehicle ECU 120 is configured to, after executing the first mode, execute control such that the second mode and

the third mode are alternately switched and executed repeatedly. The second mode executes control such that the four-way switching valve 106 opens the first flow path (a1) and the third flow path (a3). In addition, it is assumed that the second flow path (a2) to the fourth flow path (a4) is opened in the same manner. In this case, the flow path is switched so that flow occurs from the first flow path (a1) on the upstream side to the third flow path (a3), and so that flow occurs from the second flow path (a2) to the fourth flow path (a4). The third mode executes control such that the four-way switching valve 106 opens the first flow path (a1) and the fourth flow path (a4). In this case, the flow path is switched so that flow occurs from the first flow path (a1) to the fourth flow path (a4) on the downstream side. In the third mode, as the flow, the second flow path (a2) and the third flow path (a3) located on the inner side of the downstream side are blocked, so that the flow from the upstream side passes through the second heat exchanger 116 and the water pump 104, returning to the upstream side.

By switching the mode control as described above, it is possible to discharge the residual air by repeating a phase of blocking the flow path to accumulate the air and a phase of opening the flow path to discharge the air.

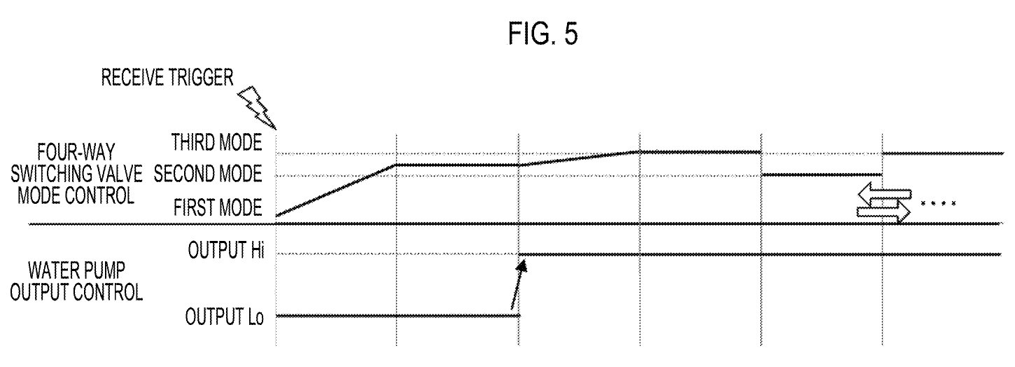

FIG. 5 shows an example of a time chart of the mode control. After the first mode is executed, the mode is transitioned to the second mode and the third mode, and then the second mode and the third mode are alternately switched and executed repeatedly. Regarding the output level of the water pump 104, the vehicle ECU 120 sets the output to Low (low output) until the transition from the first mode to the second mode, and then switches the output to High (high output) when the mode is switched from the second mode to the third mode. As a result, the blowing out of the coolant can be prevented.

### Flow of Control

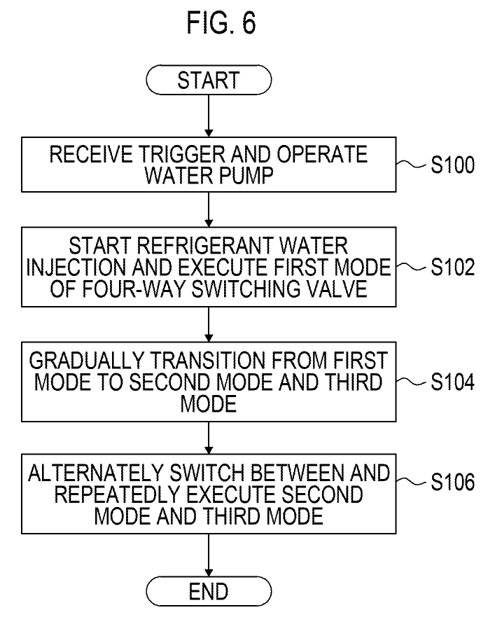

FIG. 6 is a flowchart for describing a flow of processing of the present embodiment.

In S100, the vehicle ECU 120 receives the trigger and operates the water pump 104.

In S102, the vehicle ECU 120 starts the refrigerant water injection and executes the first mode of the four-way switching valve 106. By the first mode, the second flow path (a2) and the third flow path (a3) are opened.

In S104, the vehicle ECU 120 gradually transitions the mode of the four-way switching valve 106 from the first mode to the second mode and the third mode. The first flow path (a1) and the third flow path (a3) are opened in the second mode, and the first flow path (a1) and the fourth flow path (a4) are opened in the third mode.

In S106, the vehicle ECU 120 executes control such that the mode of the four-way switching valve 106 is alternately switched between the second mode and the third mode. The repetition is executed until either a predetermined time elapses or the discharge of the residual air is detected.

As described above, in the present embodiment, the discharge of the residual air is enabled in a short time in the complex refrigerant circuit of the vehicle.

In addition, by switching the flow path of the refrigerant circuit 100 while operating the water pump 104 after water is injected into the upstream path (a) where the engine 110 is located, the air can be discharged by passing the water through the downstream path where air bubbles are less likely to be released. Further, by automatically controlling the control of the switching of the flow path by the vehicle ECU 120, the reduction in the operation time is achieved.

The various types of processing executed by the CPU reading and executing the software (program) in the embodiment may be executed by various types of processors other than the CPU. Examples of the processor in this case include a programmable logic device (PLD) such as a field-programmable gate array (FPGA) that is capable of changing a circuit configuration after manufacturing, and a dedicated electric circuit having a circuit configuration designed to execute specific processing, such as a graphics processing unit (GPU) and an application specific integrated circuit (ASIC). Each of the types of processing described above may be executed by one of the various types of processors or may be executed by a combination of two or more processors of the same or different types (for example, a combination of a plurality of FPGAs, or a combination of a CPU and an FPGA). In addition, the hardware structure of each of the various processors is more specifically an electric circuit in which circuit elements, such as semiconductor elements, are combined.

In the embodiment, the information processing program has been described in a form in which the information processing program is stored (installed) in a non-transitory recording medium that can be read by a computer. For example, the information processing program is stored in a ROM or a storage in advance. However, the present disclosure is not limited thereto, and each program may be provided in a form recorded on a non-transitory recording medium, such as a compact disc read only memory (CD-ROM), a digital versatile disc read only memory (DVD-ROM), or a universal serial bus (USB) memory. The information processing program may be provided in a form in which the information processing program is downloaded from an external device via a network.

The flow of the processing described in the embodiment is an example, and within a range that does not deviate from the gist, unnecessary steps may be deleted, new steps may be added, or the processing order may be changed.

What is claimed is:

1. An air conditioning system comprising:
a refrigerant circuit; and
a controller configured to control a four-way switching valve, wherein:
the refrigerant circuit includes an engine, an air conditioning unit that is predetermined, a first heat exchanger, and a second heat exchanger that are disposed in parallel, and includes a water pump and the four-way switching valve;
the refrigerant circuit is configured such that the engine and the first heat exchanger are disposed upstream in the circuit and the air conditioning unit and the second heat exchanger are disposed downstream in the circuit, and the water pump and the four-way switching valve are provided downstream in the circuit in a symmetrical manner;
the refrigerant circuit includes a first flow path connecting the engine and the first heat exchanger to the four-way switching valve, a second flow path connecting the water pump to the four-way switching valve, a third flow path connecting the air conditioning unit to the four-way switching valve, and a fourth flow path connecting the second heat exchanger to the four-way switching valve; and
the controller is configured to, during refrigerant water injection, execute a first mode in which the four-way switching valve is controlled to open the second flow path and the third flow path, and, after executing the first mode, execute control such that a second mode in which the four-way switching valve is controlled to open the first flow path and the third flow path and a third mode in which the four-way switching valve is controlled to open the first flow path and the fourth flow path are alternately switched and executed repeatedly.

2. The air conditioning system according to claim 1, wherein the controller is configured to execute control such that an output of the water pump is a low output until a transition from the first mode to the second mode, and then the output is switched to a high output when the mode is switched from the second mode to the third mode.

3. A control method of an air conditioning system, the control method being used to control a refrigerant circuit and a controller configured to control a four-way switching valve, in which:
the refrigerant circuit includes an engine, an air conditioning unit that is predetermined, a first heat exchanger, and a second heat exchanger that are disposed in parallel, and includes a water pump and the four-way switching valve;
the refrigerant circuit is configured such that the engine and the first heat exchanger are disposed upstream in the circuit and the air conditioning unit and the second heat exchanger are disposed downstream in the circuit, and the water pump and the four-way switching valve are provided downstream in the circuit in a symmetrical manner; and
the refrigerant circuit includes a first flow path connecting the engine and the first heat exchanger to the four-way switching valve, a second flow path connecting the water pump to the four-way switching valve, a third flow path connecting the air conditioning unit to the four-way switching valve, and a fourth flow path connecting the second heat exchanger to the four-way switching valve, the control method comprising causing the controller to, during refrigerant water injection, execute a first mode in which the four-way switching valve is controlled to open the second flow path and the third flow path, and, after executing the first mode, execute control such that a second mode in which the four-way switching valve is controlled to open the first flow path and the third flow path and a third mode in which the four-way switching valve is controlled to open the first flow path and the fourth flow path are alternately switched and executed repeatedly.
